(19) United States
(12) Patent Application Publication
(10) Pub. No.: US 2011/0150735 A1
(43) Pub. Date: Jun. 23, 2011

(54) Fabrication of Transparent Ceramics Using Nanoparticles Synthesized Via Flame Spray Pyrolysis

(75) Inventors: Jeffery J. Roberts, Livermore, CA (US); Nerine J. Cherepy, Oakland, CA (US); Joshua D. Kuntz, Livermore, CA (US)

(73) Assignee: Lawrence Livermore National Security, LLC.

(21) Appl. No.: 11/924,394

(22) Filed: Oct. 25, 2007

Related U.S. Application Data
(60) Provisional application No. 60/856,189, filed on Nov. 1, 2006.

(51) Int. Cl. C01F 17/00; C04B 35/64; B82Y 40/00

(52) U.S. Cl. 423/263; 264/681; 264/483; 977/896

(57) ABSTRACT

A method of fabrication of a transparent ceramic using nanoparticles synthesized via flame spray pyrolysis includes providing metal salts, dissolving said metal salts to form organic precursors in solution, aerosolizing said solution, oxidizing said aerosol in a flame, yielding oxide nano-particles, forming said oxide nano-particles into a green body, and sintering said green body to produce the transparent ceramic. Fabrication of transparent ceramic scintillators by this route that offer performance similar to that of single crystal scintillators has been demonstrated.

### CROSS-REFERENCE TO RELATED APPLICATIONS

This application claims the benefit of U.S. Provisional Patent Application No. 60/856,189 filed Nov. 1, 2006 by Jeffery J. Roberts, Nerine J. Cherepy, and Joshua D. Kuntz and titled “Method for Fabrication of Transparent Ceramics Using Nanoparticles Synthesized via Flame Spray Pyrolysis” is incorporated herein by this reference.

The United States Government has rights in this invention pursuant to Contract No. DE-AC52-07NA27344 between the United States Department of Energy and Lawrence Livermore National Security, LLC for the operation of Lawrence Livermore National Laboratory.

### BACKGROUND

1. Field of Endeavor

The present invention relates to ceramics and more particularly to fabrication of transparent ceramics using nanoparticles.

2. State of Technology

Generally, poreless ceramics have excellent mechanical, thermal, electrical, chemical and optical properties. Transparent ceramic materials can be used as optics, such as scintillators, laser media and lenses. Current methods typically use ceramics feedstock derived from co-precipitation, sol-gel and other wet chemical routes. For example United States Published Patent Application No. 2005/0019241 by Robert Joseph Lyons, “Preparation of Rare Earth Ceramic Garnet,” uses oxalate precursors and ball milling steps for deagglomeration. Wet chemical methods for transparent ceramics feedstock production involve huge solvent costs, produce large amounts of waste water and need calcination steps after the synthesis, making feedstock thus produced an expensive step in the manufacturing process. Mechanical and mechanical/thermal methods such as milling are energy intensive and generally suffer from insufficient mixing at the atomic level leading to low phase stability. Flame spray pyrolysis (FSP) is a known process and has been used for preparation of many oxides, for example U.S. Pat. No. 7,211,236, issued May 1, 2007, describes the production of ceria, zirconia and mixed ceria/zirconia. Demonstration of the ease of fabrication of transparent ceramics from FSP feedstock and their superior performance is the basis of this invention.

### SUMMARY

Features and advantages of the present invention will become apparent from the following description. Applicants are providing this description which includes drawings and examples of specific embodiments to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a method of making a transparent ceramic. The method includes the steps of providing metal salts, dissolving and stirring the metal salts to produce organo-metallic precursors in organic solution, aerosolizing the solution, oxidizing the aerosol in a flame, yielding oxide nano-particles, forming the oxide nano-particles into a green body, and sintering the green body to produce the transparent ceramic.

The present invention teaches a superior method to produce a transparent ceramic. For example, some of the improved characteristics of the method include using non-agglomerated nano-particles that have a narrow size distribution and that are substantially monodisperse. In one embodiment, the non-agglomerated nano-particles have a narrow size distribution with an average particle size of 5-50 nm.

In various embodiments, the step of providing metal salts may include providing nitrate, chloride, acetate, acetylacetonate, or carbonate metal salts or a combination of the nitrate, chloride, acetate, acetylacetonate, or carbonate metal salts. In various embodiments, the step of oxidizing the aerosol in a flame may include oxidizing the aerosol in a flame for optimal particle formation by adjusting the injection rate, adjusting the flame composition, adjusting the dispersion oxygen rate and pressure difference, or adjusting the flame height. In various embodiments, the step of forming the oxide nano-particles into a green body may include uniaxial pressing, cold isostatic pressing, or slip casting the oxide nano-particles to form a green body. In various embodiments the step of sintering the green body to produce the transparent ceramic may include vacuum sintering, controlled atmosphere sintering, pulsed-electric current sintering, plasma sintering, microwave sintering, laser sintering, radio-frequency sintering, hot-pressing, or hot-isostatic pressing the green body to produce the transparent ceramic.

In various embodiments, the transparent ceramic has a cubic garnet structure including Lu₃Al₅O₁₂, Y₃Al₅O₁₂, Gd₃Al₅O₁₂ and related materials, (A₁₋ₓ, Bₓ, etc.)₃(C_{1-y}, D_{y}, etc.)₅O₁₂ where first site (A, B, etc.) can contain any mixture of the following that results in the garnet structure: Y, Gd, Lu, La, Tb, Pr; and the second site (C, D, etc.) site can contain any mixture of the following that results in the garnet structure: Al, Ga, Sc.

One embodiment of the present invention provides a method of fabricating a transparent oxide ceramic scintillator. The method includes the steps of providing metal salts of Lu, Al, and Ce, dissolving and stirring the metal salts to produce organo-metallic precursors in organic solution, aerosolizing the solution, oxidizing the aerosol in a flame yielding oxide nano-particles, forming the oxide nano-particles in to a green body, and sintering the green body to produce the transparent oxide ceramic scintillator.

Wet chemical methods for transparent ceramics feedstock production involve huge solvent costs, produce large amounts of waste water and need calcination steps after synthesis, making wet chemistry-derived feedstock an expensive step in the manufacturing process. Flame spray pyrolysis (FSP) particle synthesis has further specific advantages, such as: high purity, possibility to form exact stoichiometry in mixed metal oxides, lack of surface contamination, uniform primary particle size in the 5-50 nm range, spherical particle shape, very weak agglomeration of primary particles and production of crystalline particles in the single step of flame pyrolysis. Not only does FSP particle synthesis require less steps than wet chemical synthesis, but the aforementioned advantageous properties of the FSP particles reduce the number of ceramics processing steps. Mechanical and mechanical/thermal methods required for processing agglomerated particles obtained by other synthesis routes, such as milling, are energy intensive and can lead to contamination of the particles. Applicants have demonstrated the superiority of fabrication of transparent ceramics from FSP feedstock. The present invention has many uses. For example, the present invention has use in producing transparent optical ceramics for multiple uses including optics, windows, blast shields, laser media, electro-optic switches, magneto-optic switches, and laser crystals. The present invention also has use in producing scintillator crystals for radiation detectors. The present invention has use for transparent armor. The present invention has use for shock resistant windows for weapons or sensors. The present invention has use for missile domes. The present invention also has use in producing scintillators for X-ray imaging, computed tomography (CT) screens, and positron emission tomography (PET) detectors.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates an embodiment of the present invention showing a method of synthesizing nanoparticles using flame spray pyrolysis to produce transparent ceramics.

FIG. 2 illustrates an embodiment of the present invention showing a method of fabricating a transparent oxide ceramic scintillator.

FIG. 3 illustrates the spherical monodisperse nature of particles synthesized via flame spray pyrolysis that provide superior feedstock for creating transparent ceramics.

FIG. 4 illustrates transparent ceramic parts of Lutetium Aluminum Garnet prepared as illustrated in FIG. 2.

FIG. 5 illustrates the comparative light yields of ceramic versus single crystal materials.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

The present invention provides the fabrication of transparent ceramics using methods of synthesizing nanoparticles using flame spray pyrolysis. The method includes the steps of providing metal salts, dissolving and stirring the metal salts to produce organo-metallic precursors in organic solution, aerosolizing the solution, oxidizing the aerosol in a flame, yielding oxide nano-particles, forming the oxide nano-particles into a green body, and sintering the green body to produce the transparent ceramic.

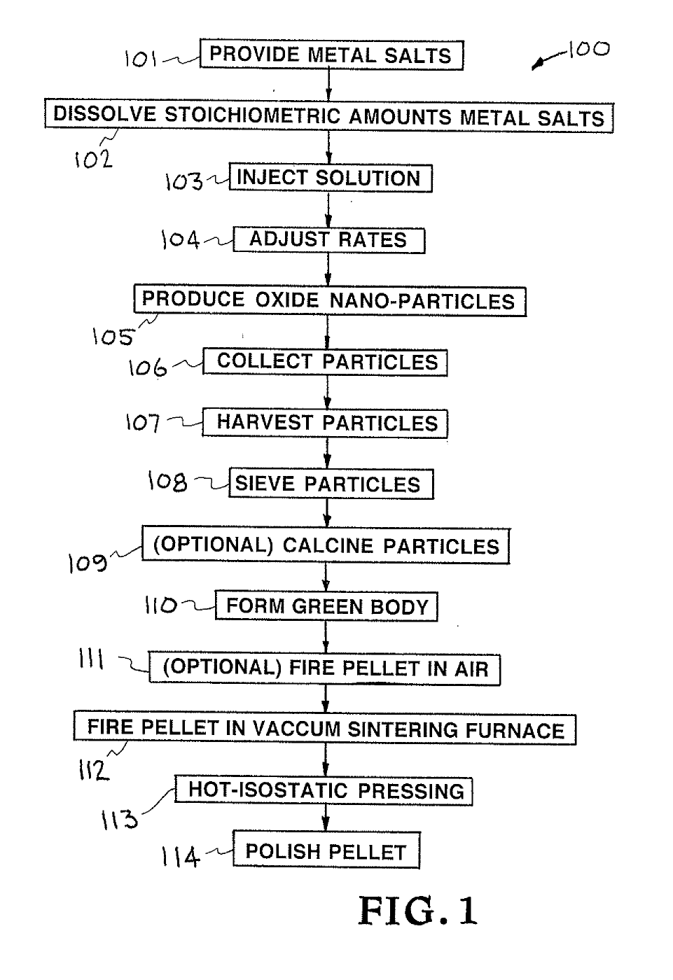

Referring now to the drawings and in particular to FIG. 1, a method of synthesizing nanoparticles using flame spray pyrolysis to provide transparent ceramic materials is illustrated. The method is designated generally by the reference numeral 100. The method 100 includes the following steps:

Step # 101 Provide metal salts (such as nitrate, chloride, acetate, acetylacetonate, carbonate, isopropylate, oxalate, ethylhexanoate etc. and mixtures of the above).

Step # 102 Dissolve stoichiometric amounts of metals salts of step 101 in organic solvent mixture (ethanol, acetic anhydride, acetonitrile, ethylhexanoic acid, xylene, THF, alcohols, etc.).

Step # 103 Inject solution of step 102 into ignited flame spray reactor.

Step # 104 Adjust injection rate, flame composition, dispersion oxygen rate and pressure difference, and flame height, for optimal particle formation.

Step # 105 Produce oxide nano-particles.

Step # 106 Collect particles by pressure differential or electrostatic precipitation on a collector plate, bag house filter or other similar means.

Step # 107 Harvest particles from collector.

Step # 108 Sieve particles to reduce agglomeration.

Step # 109 (Optional) Calcine particles to remove organic material Step # 110 Form a green body (slip casting, cold pressing, cold isostatic pressing, etc. of particles in a mold to form green body).

Step # 111 (Optional) Fire pellet in air.

Step # 112 Fire pellet in a sintering furnace to greater than 95% Theoretical Density (TD) (said sintering may include vacuum sintering, controlled atmosphere sintering, pulsed-electric current sintering, plasma sintering, microwave sintering, laser sintering, radio-frequency sintering, or hot-pressing said green body to produce the transparent ceramic.). (In other embodiments, the steps of forming the oxide nano-particles into a green body and sintering the green body may include (a) green body formation via uniaxial pressing, cold isostatic pressing, or slip casting, (b) followed by consolidation via vacuum sintering, controlled atmosphere sintering, pulsed-electric current sintering, plasma sintering, microwave sintering, laser sintering, radio-frequency sintering, or hot-pressing, and (c) subsequent hot isostatic pressing to improve clarity, or any combination thereof).

Step # 113 Perform hot-isostatic pressing to remove remaining pores.

Step # 114 Polish pellet—produces a transparent ceramic. (In various embodiments the transparent ceramic has a cubic garnet structure including Lu₃Al₅O₁₂, Y₃Al₅O₁₂, Gd₃Al₅O₁₂ and related materials, (Al₁₋ₓ,Bₓ, etc.)₃(C_{1-y}, D_{y}, etc.)₅O₁₂ where first site (A, B, etc.) can contain any mixture of the following that results in the garnet structure: Y, Gd, Lu, La, Tb, Pr; and the second site (C, D, etc.) site can contain any mixture of the following that results in the garnet structure: Al, Ga, Sc).

Flame spray pyrolysis, as described by Madler et al. (2002) and Pratsinis (1996, 1998), is used to synthesize oxide nano-powder. Nanoparticles synthesized using the flame spray pyrolysis method are found to have a narrow particle size distribution, uniform composition, and highly spherical particles exhibiting little to no agglomeration. Precursors were prepared by dissolving stoichiometric amounts of metal salts in organic solvents (steps 101 and 102). The salts and solvents vary depending on the specific compound to be synthesized. Typically, the metal-salts are dissolved in a combustible organic solvent mixture in varying proportions depending on specific salt solubility. The resulting solution is injected into the flame spray reactor at a controlled rate (steps 103 and 104). The combustion fuel to the flame spray reactor is turned on and the mixture adjusted prior to igniting the flame. (step 104). The injected fluid is atomized with oxygen and injected into a methane/oxygen flame (step 104). The rate of oxygen flow for atomization and the pressure difference between ambient pressure and the injector is adjusted for optimal atomization (step 104). Oxygen flow rates and the pressure difference are dependent on several factors including desired particle size, type of material, flow rate and level of oxygenation. The organic solvents and metal salts combust in the flame, creating nano-scale particles that are collected using a filter plate (steps 105 and 106). Temperature at the filter plate in the collector is monitored to prevent damage to the filter. Adjusting the distance between the flame spray reactor and the filter plate controls the temperature. Following the completion of solvent combustion, the particles are harvested from the filter paper within a hood to prevent the un-wanted dispersal of nano-particles (step 107). Particles can then be sieved to reduce the light agglomeration than can occur (step 108). Particles can then be calcined in air to remove organic residue (step 109).

The next steps involve forming, pressing, firing, sintering, and polishing the transparent ceramic pellet. The nano-particles produced above (steps 107, 108, 109) are then forming into a green body or pellet (step 110). This is typically done by uniaxial pressing or slip casting followed by an optional step of cold isostatic pressing. The resulting pellet can then be calcined in air (step 111). The resulting pellet is then sintered in vacuum to a density greater than 95% TD, until there is no open porosity (step 112). The sintered body is then hot-isostatically pressed to remove residual closed porosity (step 113). Polishing the sintered and HIP'ed body produces a transparent ceramic (step 114).

Various embodiments of the present invention include providing nitrate, chloride, acetate, acetylacetonate, or carbonate metal salts or a combination of the nitrate, chloride, acetate, acetylacetonate, or carbonate metal salts in the step of providing metal salts. Various embodiments include oxidizing the aerosol in a flame for optimal particle formation by adjusting the injection rate, adjusting the flame composition, adjusting the dispersion oxygen rate and pressure difference, or adjusting the flame height in the step of oxidizing the aerosol in a flame. Various embodiments include uniaxial pressing, cold isostatic pressing, or slip casting the oxide nano-particles to form a green body in the step of forming the oxide nano-particles into a green body. Various embodiments include vacuum sintering, controlled atmosphere sintering, pulsed-electric current sintering, plasma sintering, microwave sintering, laser sintering, radio-frequency sintering, hot-pressing, or hot-isostatic pressing the green body to produce the transparent ceramic in the step of sintering the green body to produce the transparent ceramic.

Some of the features of the particles synthesized by flame spray pyrolysis (FSP particles) are: (1) high uniformity of particle size (near monodisperse size distribution), (2) low degree of primary particle aggregation, (3) high purity and (4) formation of single phase nanoparticles. These properties of the FSP particles allow simpler, lower-cost processing into transparent ceramics. In various embodiments, the transparent ceramic has a cubic garnet structure including Lu₃Al₅O₁₂, Y₃Al₅O₁₂, Gd₃Al₅O₁₂ and related materials, (A₁₋ₓ,Bₓ, etc.)₃(C_{1-y}, D_{y}, etc.)₅O₁₂ where first site (A, B, etc.) can contain any mixture of the following that results in the garnet structure: Y, Gd, Lu, La, Tb, Pr; and the second site (C, D, etc.) site can contain any mixture of the following that results in the garnet structure: Al, Ga, Sc.

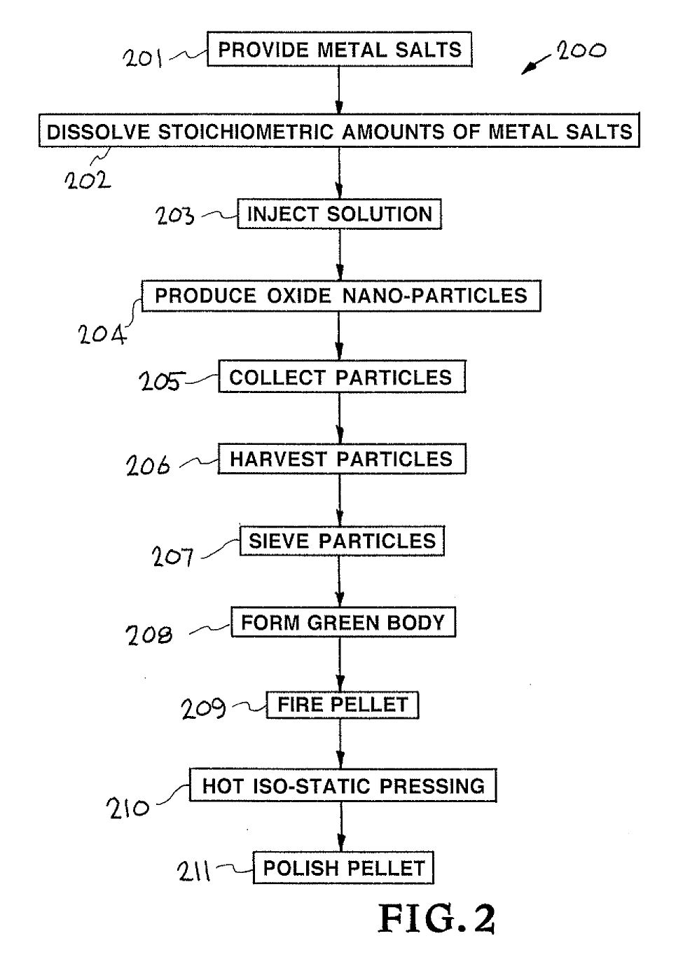

Producing a transparent ceramic using Lutetium Aluminum Garnet (LuAG) nanoparticle feedstock, the present invention provides a method for fabrication of transparent ceramics using the method of synthesizing nanoparticle feedstock via flame spray pyrolysis (FSP). In one embodiment, the present invention provides a method of fabrication of a LuAG transparent ceramic using nanoparticle feedstock derived from flame spray pyrolysis. Referring to the drawings and in particular to FIG. 2, a method of fabrication of a LuAG transparent ceramic using nanoparticle feedstock derived from flame spray pyrolysis is illustrated. The method is designated generally by the reference numeral 200. The method 200 includes the following steps:

Step # 201 Provide metal salts (acetylacetonate) of Lu, Al, and Ce.

Step # 202 Dissolve stoichiometric amounts of metals salts of step 201 in organic solvent mixture of near-equal proportions of acetic anhydride, acetonitrile, and ethylhexanoic acid.

Step # 203 Inject solution of step 202 into ignited flame spray reactor.

Step # 204 Produce oxide nano-particles.

Step # 205 Collect particles on high-temperature filter paper within a collector body using a vacuum pump to create negative pressure on the paper.

Step # 206 Harvest particles from filter paper.

Step # 207 Sieve particles to reduce agglomeration.

Step # 208 Form a green body by cold pressing in a mold.

Step # 209 Fire pellet in vacuum sintering furnace to greater than 95% TD

Step # 210 Perform hot-isostatic pressing to remove remaining pores.

Step # 211 Polish pellet—produces a transparent ceramic.

Flame spray pyrolysis, as described by Madler et al. (2002) and Pratsinis (1996, 1998), is used to synthesize LuAG oxide nano-powder. Precursors were prepared by dissolving stoichiometric amounts of metal salts in organic solvents consisting of equal proportions acetic anhydride, acetonitrile, and ethylhexanoic acid (steps 201 and 202). This solution is injected into the flame spray reactor at a controlled rate (steps 203 and 204). The combustion fuel to the flame spray reactor is turned on and the mixture adjusted prior to igniting the flame. (step 203). The injected fluid is atomized with oxygen and injected into a methane/oxygen flame (step 204). The organic solvents and metal salts combust in the flame, creating nano-scale particles that are collected using a liquid cooled filter plate (steps 205 and 206). Temperature at the filter plate in the collector is monitored to prevent damage to the filter. Adjusting the distance between the flame spray reactor and the filter plate controls the temperature. Following the completion of solvent combustion, the particles are harvested from the filter paper within a hood to prevent the unwanted dispersal of nano-particles (step 206). Particles are then sieved with a 310 micron or finer mesh to reduce the light agglomeration that occurs (step 207). Thus produced, the particles will exhibit a substantially monodisperse size distribution, due to the controlled droplet size in the aerosol and the short residence time in the reactive flame. Additionally, the non-aqueous solvents are cleanly removed in the flame, resulting in particles possessing high purity and a low degree of agglomeration. The next steps (steps 208, 209, 210, 211) involve forming, pressing, firing, sintering, and polishing the transparent ceramic pellet. The nano-particles produced above are then formed into a green body or pellet by cold pressing (step 208). The resulting pellet is then sintered in vacuum to a density greater than 95% TD, until there is no open porosity (step 209). The sintered body is then hot-isostatically pressed to remove residual closed porosity (step 210). Polishing the sintered and HIP'ed body produces a transparent ceramic (step 211).

The present invention provides a transparent oxide ceramic product produced by the process of the present invention. The process includes the steps of providing metal salts, dissolving and stirring said metal salts to produce organo-metallic precursors in organic solution, aerosolizing said solution, oxidizing said aerosol in a flame yielding oxide nano-particles including oxidizing said aerosol yielding oxide nano-particles that have a narrow size distribution in the range of 5-50 nm and using said nanoparticles to produce the transparent ceramic, forming said oxide nano-particles into a green body, and sintering said green body to produce the transparent ceramic product.

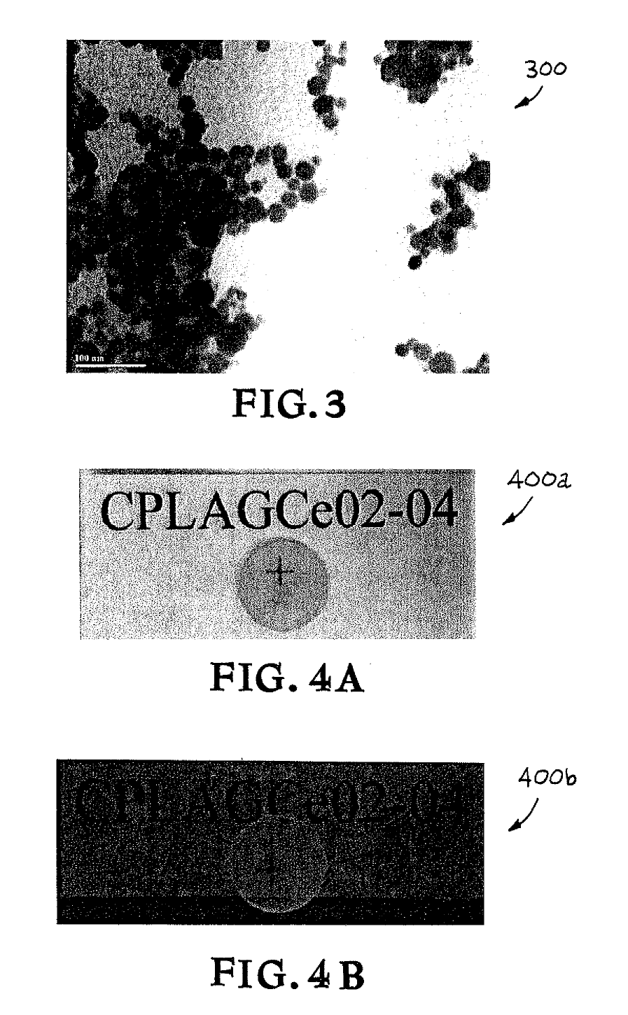

Referring now to FIG. 3, a TEM image 300 of flame spray particles showing their spherical, monodisperse, non-agglomerated characteristics. Average particle size for the sample shown is 8-11 nm. FIG. 3 illustrates the spherical monodisperse nature of particles synthesized via flame spray pyrolysis that provide superior feedstock for creating transparent ceramics. The monodisperse nature of particles synthesized via flame spray pyrolysis produced by the method of the present invention provides a superior transparent ceramic. The non-agglomerated nano-particles having a narrow size distribution providing a superior transparent ceramic. FIG. 3 shows a transmission electron micrograph of Lutetium Aluminum Garnet (LuAG) nanoparticles, as synthesized by flame spray pyrolysis (FSP).

FIGS. 4A and 4B illustrate a transparent ceramic part of LuAG prepared as illustrated in FIG. 1 and described above. FIG. 4A shows a cold pressed, then vacuum sintered ceramic 400a under visible light illumination. FIG. 4B shows the same ceramic identified by the reference numeral 400b under UV illumination. This ceramic exhibits scintillation light yield superior to that of single crystals of the same material, due to the higher Ce-doping possible with in the ceramic. Pulse height spectra indicate that ceramic scintillators prepared following this method can replace single crystal scintillators for applications involving radioisotope identification.

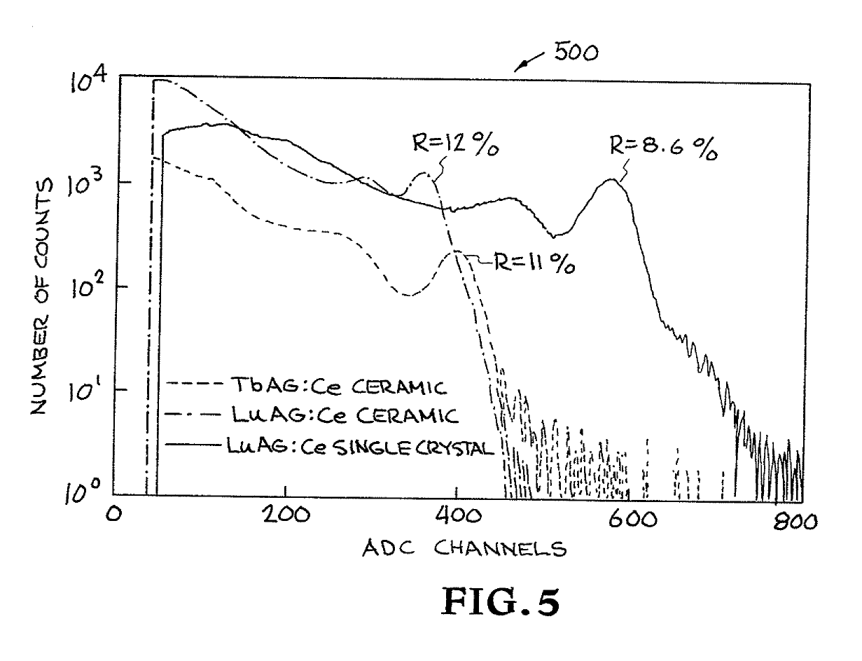

FIG. 5 shows the pulse height spectra obtained for Lutetium Aluminum Garnet and Terbium Aluminum Garnet ceramics, along with that of a Lutetium Aluminum Garnet single crystal, clear photopeaks are observed for all materials for 662 keV gamma excitation.

The present invention has many uses. For example, the present invention has use in producing transparent optical ceramics for multiple uses including optics, windows, blast shields, laser media, electro-optic switches, magneto-optic switches, and laser crystals. The present invention also has use in producing scintillator crystals for radiation detectors. The present invention has use for transparent armor. The present invention has use for shock resistant windows for weapons or sensors. The present invention has use for missile domes. The present invention also has use in producing scintillators for X-ray imaging, computer tomography (CT) screens, and positron emission tomography (PET) detectors.

Some of the advantages of FSP particles as feedstock for transparent ceramics are: (1) non-agglomerated particles with a narrow particle size distribution obviate the need for either ball milling (a process which is energy intensive and can lead to contamination) or particle sorting; (2) high purity, monodisperse, spherical particles as-synthesized can be cold pressed into a green body that is translucent, demonstrating uniform packing density of the green body; and (3) the green body thus formed is readily transformed via sintering into a strong, dense transparent material that exhibits properties equivalent to or superior to a single crystal of the same crystal structure and composition. In particular, mechanical properties, thermal shock resistance, uniformity of dopant distribution (used in scintillators and laser crystals), and homogeneity of ceramics are superior to that of single crystals. Additionally, ceramics are formable into large and complex near-net shapes, difficult to attain with single crystals.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A method of making a transparent ceramic, comprising the steps of:
providing metal salts,
dissolving and stirring said metal salts to produce organo-metallic precursors in organic solution,
aerosolizing said solution,
oxidizing said aerosol in a flame yielding oxide nano-particles,
forming said oxide nano-particles into a green body, and
sintering said green body to produce the transparent ceramic.

2. The method of claim 1, wherein said step of oxidizing said aerosol in a flame yielding oxide nano-particles includes oxidizing said aerosol yielding oxide nano-particles that have a narrow size distribution and said nanoparticles are used to produce the transparent ceramic.

3. The method of claim 2, wherein said nano-particles that have a narrow size distribution have a narrow size distribution in the range of 5-50 nm and that are substantially monodisperse.

4. The method of claim 1, wherein said step of providing metal salts comprises providing nitrate, chloride, acetate, acetylacetonate, or carbonate metal salts or a combination of said nitrate, chloride, acetate, acetylacetonate, or carbonate metal salts.

5. The method of claim 1, wherein said step of oxidizing said aerosol in a flame comprises oxidizing said aerosol in a flame for optimal particle formation by adjusting the injection rate, adjusting the flame composition, adjusting the dispersion oxygen rate and pressure difference, or adjusting the flame height.

6. The method of claim 1, wherein said step of forming said oxide nano-particles into a green body comprises uniaxial pressing, cold isostatic pressing, or slip casting said oxide nano-particles to form a green body.

7. The method of claim 1, wherein said step of sintering said green body to produce the transparent ceramic comprises vacuum sintering, controlled atmosphere sintering, pulsed-electric current sintering, plasma sintering, microwave sintering, laser sintering, radio-frequency sintering, or hot-pressing said green body to produce the transparent ceramic.

8. The method of fabricating a transparent ceramic of claim 1, wherein said step of sintering said green body to produce the transparent ceramic comprises vacuum sintering said green body for 2-12 hours at 1500-1900° C. to produce the transparent ceramic.

9. The method of claim 1, wherein said steps of forming said oxide nano-particles into a green body and sintering said green body comprise:
(a) green body formation via uniaxial pressing, cold isostatic pressing, or slip casting,
(b) followed by consolidation via vacuum sintering, controlled atmosphere sintering, pulsed-electric current sintering, plasma sintering, microwave sintering, laser sintering, radio-frequency sintering, or hot-pressing, and
(c) subsequent hot isostatic pressing to improve clarity, or any combination thereof.

10. The method of fabricating a transparent ceramic of claim 1, wherein the transparent ceramic has a cubic garnet structure including Lu₃Al₅O₁₂, Y₃Al₅O₁₂, Gd₃Al₅O₁₂ and related materials, (A₁₋ₓ,Bₓ, etc.)₃(C_{1-y}, D_{y}, etc.)₅O₁₂ where first site (A, B, etc.) can contain any mixture of the following that results in the garnet structure: Y, Gd, Lu, La, Tb, Pr; and the second site (C, D, etc.) site can contain any mixture of the following that results in the garnet structure: Al, Ga, Sc.

11. A method of fabricating a transparent ceramic, comprising the steps of:
providing nitrate, chloride, acetate, acetylacetonate, or carbonate non-agglomerate metal salts or a combination of said nitrate, chloride, acetate, acetylacetonate, or carbonate non-agglomerate metal salts,
dissolving and stirring said metal salts to produce organo-metallic precursors in organic solution,
aerosolizing said solution,
oxidizing said aerosol in a flame yielding oxide nano-particles,
forming said oxide nano-particles in to a green body, and
vacuum sintering said green body for 2-12 hours at 1500-1900° C. to produce the transparent ceramic.

12. The method of claim 11, wherein said step of oxidizing said aerosol in a flame yielding oxide nano-particles includes oxidizing said aerosol yielding oxide nano-particles that have a narrow size distribution in the range of 5-50 nm and said nanoparticles are used to produce the transparent ceramic.

13. The method of claim 11, wherein said step of oxidizing said aerosol in a flame yielding oxide nano-particles comprises oxidizing said aerosol in a flame for optimal particle formation by adjusting the injection rate, adjusting the flame composition, adjusting the dispersion oxygen rate and pressure difference, or adjusting the flame height.

14. The method of claim 11, wherein said step of sintering said green body to produce the transparent ceramic comprises vacuum sintering, controlled atmosphere sintering, pulsed-electric current sintering, plasma sintering, microwave sintering, laser sintering, radio-frequency sintering, or hot-pressing said green body to produce the transparent ceramic.

15. The method of fabricating a transparent ceramic of claim 11, wherein said steps of forming a green body and sintering said green body comprise:
(a) green body formation via uniaxial pressing, cold isostatic pressing, or slip casting,
(b) followed by consolidation via vacuum sintering, controlled atmosphere sintering, pulsed-electric current sintering, plasma sintering, microwave sintering, laser sintering, radio-frequency sintering, or hot-pressing, and
(c) subsequent hot isostatic pressing to improve clarity, or any combination thereof.

16. A method of fabricating a transparent oxide ceramic scintillator, comprising the steps of:
providing metal salts of Lu, Al, and Ce,
dissolving and stirring said metal salts to produce an aqueous salt solution,
adding an organic chelating agent to produce organo-metallic precursors in organic solution,
aerosolizing said solution,
oxidizing said aerosol in a flame yielding oxide nano-particles,
forming said oxide nano-particles in to a green body, and
sintering said green body to produce the transparent oxide ceramic scintillator.

17. The method of fabricating a transparent oxide ceramic scintillator of claim 16, wherein said step of oxidizing said aerosol in a flame yielding oxide nano-particles includes oxidizing said aerosol yielding oxide nano-particles that have a narrow size distribution in the range of 5-50 nm and said nanoparticles are used to produce the transparent ceramic.

18. The method of fabricating a transparent oxide ceramic scintillator of claim 16, wherein said step of oxidizing said aerosol in a flame yielding oxide nano-particles comprises oxidizing said aerosol in a flame for optimal particle formation by adjusting the injection rate, adjusting the flame composition, adjusting the dispersion oxygen rate and pressure difference, or adjusting the flame height.

19. The method of fabricating a transparent oxide ceramic scintillator of claim 16, wherein said step of forming said oxide nano-particles into a green body comprises uniaxial pressing, cold isostatic pressing, or slip casting said oxide nano-particles to form a green body.

20. The method of fabricating a transparent oxide ceramic scintillator of claim 16, wherein said step of sintering said green body to produce the transparent ceramic comprises vacuum sintering, controlled atmosphere sintering, pulsed-electric current sintering, plasma sintering, microwave sintering, laser sintering, radio-frequency sintering, or hot-pressing said green body to produce the transparent ceramic.

21. The method of fabricating a transparent oxide ceramic scintillator of claim 16, wherein said step of sintering said green body to produce the transparent ceramic comprises vacuum sintering for 2-12 hours at 1500-1900° C. to produce the transparent ceramic.

22. The method of fabricating a transparent oxide ceramic scintillator of claim 16, including the step of activating the scintillator using Ce or Pr.

23. The method of fabricating a transparent oxide ceramic scintillator of claim 16, including the step of activating the scintillator using Bi, Eu, Tb, Gd, Sm, Er, or Nd or a combination Bi, Eu, Tb, Gd, Sm, Er, or Nd resulting in strong luminescence.

24. A method of fabricating a transparent oxide ceramic scintillator, comprising the steps of:
providing metal salts of Lu, Al, and Ce,
dissolving and stirring said metal salts to produce organo-metallic precursors in organic solution,
aerosolizing said solution,
oxidizing said aerosol in a flame yielding oxide nano-particles, wherein said step includes oxidizing said aerosol yielding oxide nano-particles that have a narrow size distribution in the range of 5-50 nm and that produce the transparent ceramic with nano-particles that are substantially monodisperse,
forming said oxide nano-particles in to a green body, and
sintering said green body for 2-12 hours at 1500-1900° C. to produce the transparent oxide ceramic scintillator.

25. A transparent oxide ceramic product produced by the process comprising the steps of:
providing metal salts,
dissolving and stirring said metal salts to produce organo-metallic precursors in organic solution,
aerosolizing said solution,
oxidizing said aerosol in a flame yielding oxide nano-particles including oxidizing said aerosol yielding oxide nano-particles that have a narrow size distribution in the range of 5-50 nm and using said nanoparticles to produce the transparent ceramic,
forming said oxide nano-particles into a green body, and
sintering said green body to produce the transparent ceramic product.
